(19) United States
(12) Patent Application Publication
(10) Pub. No.: US 2021/0119490 A1
(43) Pub. Date: Apr. 22, 2021

(54) AN RF POWER HARVESTING INSERT FOR A WRISTWATCH

(71) Applicant: DRAYSON TECHNOLOGIES (EUROPE) LIMITED, London (GB)

(72) Inventors: Aline Coelho DE SOUSA, London (GB); Bruno Roberto FRANCISCATTO, London (GB); Vitor Andrade FREITAS, London (GB)

(21) Appl. No.: 16/606,523

(22) PCT Filed: Mar. 29, 2018
(86) PCT No.: PCT/GB2018/050871

§ 371 Date: Oct. 18, 2019

(30) Foreign Application Priority Data
Apr. 28, 2017 (GB) 1706865.1

(51) Int. Cl. H02J 50/27; G04C 10/00; H02J 50/00; H01Q 1/27

(52) U.S. Cl. CPC H02J 50/27; G04C 10/00; H01Q 1/248; H01Q 1/273; H02J 50/001

(57) ABSTRACT

An RF power harvesting insert (100) for a wrist-watch, the insert comprising a dielectric substrate (102) and an antenna (104) tuned to harvest power from RF electromagnetic fields to provide a radio frequency electrical signal and comprising a track of electrically conductive material on the substrate, wherein the antenna is carried by an annular region of a first surface of the substrate.

### FIELD OF INVENTION

The present disclosure relates to methods and apparatus for harvesting energy from stray electromagnetic fields which may be emitted from electrical and electronic devices. The present disclosure also provides antennas designed to harvest power from such fields, more specifically RF power harvesting inserts for wristwatches.

### BACKGROUND

The ability to transfer electrical energy over an air gap, or in vacuum, by means of alternating electromagnetic fields is well known. Two distinct applications have been developed for this phenomenon: wireless power transfer on the one hand, and wireless power harvesting on the other. The former relies upon the deliberate transfer of power from a dedicated transmit coil to a dedicated receive coil. The latter relies upon stray electromagnetic fields, such as those generated by switching of electronic devices or by telecommunications transmitters, to harvest or scavenge power from their environment.

In the field of wireless power transfer systems to transfer electrical power using alternating electrical field (E-field) and/or alternating magnetic field (H-field). Some wireless power transfer systems operate using so-called near-field coupling. Although it is less common, others may use far-field coupling.

Typically, H-field power transfer, also known as inductive power transfer may be more effective in the near-field, whereas in the far-field E-field effects may be more useful.

Wireless battery chargers and near-field RF communications devices both use inductive coupling to transfer power via an alternating H-field. Wireless battery chargers are in widespread use. Such chargers may include coils which operate, in effect, as the primary coil of a transformer, and couple inductively with a similar coil carried by the device which is to be charged. In these kinds of systems the transmitting and receiving coils can be placed in very close proximity to each other. Other types of wireless power transfer systems may operate in a similar way.

For example, near-field RF communications devices such as RFID and NFC devices are also in widespread use and are perhaps the most common type of wireless power transfer devices. The operating frequency of near field RF communications is around 13.56 MHz. The corresponding wavelength is about 22 meters. Accordingly, a half-wave dipole antenna would need to be about 11 meters in length if it were to radiate well. Generally, due to the circumstances in which they are most often used, NFC antenna area may be limited to about 7 cm×2.5 cm. The maximum linear dimension is thus about 0.5% of a wavelength—a consequence of this is that the radiation efficiency of an NFC antenna is generally very, very low. Generally therefore, the object of NFC antenna design is to occupy as large a volume as possible. Generally simple coils with multiple turns are used, and the frequency response of such inductors needs only to be specified very loosely. It barely needs to be considered at all.

Telecommunications antenna design on the other hand is a complex technical field which involves a variety of considerations. Telecommunications devices such as cellular telephone handsets, Wi-Fi® access points and routers, telecommunications network nodes such as base stations may provide relatively high energy emissions. These emissions can be used to mediate data signals over relatively long distances, and typically rely on far-field, as opposed to near-field, effects.

For wireless devices in general, and cellular telecommunications devices in particular, there is a general desire to increase communications range and to reduce energy losses in the environment immediately surrounding a wireless device. For example, cellular telephone handsets may be arranged to direct electromagnetic energy away from the body of a human user. This may assist in transmitting greater signal energy over greater distances.

Wristwatches are worn by a significant number of people and are often powered by an internal battery. While the power consumption of these devices is relatively low, the owner of a wristwatch may expect to have to change the battery at least once during the lifetime of the watch.

Many wristwatches are designed to be waterproof or water resistant and as such are sealed very carefully to ensure they meet the required water resistance standard. This cannot necessarily be replicated when changing the battery after production, potentially reducing the functionality of the wristwatch.

### SUMMARY

The disclosure provides RF power harvesters adapted for use in wristwatches. Such RF power harvesters comprise an antenna for coupling with an RF electromagnetic field to provide an alternating electrical signal. The antenna is disposed on a dielectric substrate, which may be disc shaped.

For example, an aspect of the disclosure provides an RF power harvesting insert for a wristwatch comprising: a dielectric substrate and an antenna tuned to harvest power from RF electromagnetic fields to provide a radiofrequency electrical signal and comprising a track of electrically conductive material on the substrate, wherein the antenna is carried by an annular region of a first surface of the substrate.

The track of conductive material may comprise a loop that runs parallel to the edge of the dielectric substrate, thereby being carried on an annular region of the substrate. The dimensions of the substrate may be chosen to allow the insert to occupy the full cross section of the wristwatch face or casing, thereby allowing the antenna to occupy the full cross section of the wristwatch case. A break may be provided in the conductive track forming a gap in the antenna loop. A signal connection may be provided from this gap to a rectifier. The dielectric substrate may be planar, for example it may be flat, for example it may be disc shaped.

The insert may also comprise a rectifier that is carried on the substrate and is operable to convert the radio frequency signals harvested by the antenna into a DC signal for charging a DC energy store. This may be a purely lumped component rectifier or contain at least some strip line components. Additionally, the rectifier may be surrounded by the annular region of the substrate. This means that the rectifier may be surrounded by the conductive track of the antenna. The rectifier however is not necessary surrounded by the antenna. It could be inserted into the annular region of the antenna (e.g. in the gap the antenna loop, e.g. its feed point) or it may be adjacent to the antenna feed point. It will also be appreciated in the context of the present disclosure that the antenna and rectifier could be assembled on different substrates, which may be stacked one on top of the other, e.g. in a multi-layered configuration and/or with antenna's and substrate's dielectric having different thickness and material, e.g. the antenna may be provided on a flexible substrate and rectifier on a rigid material.

The rectifier can be connected to the antenna through additional conductive track on the substrate. For example, each end of the conductive track at the break in the conductive track may be connected to a different signal link of the rectifier. This may provide a differential AC signal that the rectifier can convert to a DC signal and provide to a DC energy store.

The DC energy store can be charged by the DC output of the rectifier. The energy store can also power a timekeeping circuit and the movement of the wristwatch.

As in the aspect outlined above, the insert may further comprise a ground plane for the rectifier. This may consist of a region of conductive material carried on the substrate. In preferred embodiments, the ground plane is carried on the opposite side of the substrate to the rectifier and antenna. Optimally, this region of conductive material will at least cover the area on the substrate directly opposite the rectifier, on the other side of the substrate.

Another aspect of the disclosure provides a wristwatch comprising: a watch face for indicating the passage of time and a watch body holding timekeeping circuity behind the face, and an antenna disposed on a dielectric substrate interposed between the time keeping circuitry and the face, wherein the antenna is tuned to harvest power from RF electromagnetic fields to provide electrical power for charging a DC energy store of the wristwatch, wherein the DC energy store powers the time keeping circuitry.

The substrate of the insert may comprise a hole to allow a mechanical or electrical connection to be established between the time keeping circuitry and the watch face. This connection would allow the watch face to be updated by the time keeping circuitry and display the correct time.

### BRIEF DESCRIPTION OF DRAWINGS

Embodiments of the disclosure will now be described in detail with reference to the accompanying drawings, in which:

FIG. 1 shows a top down view of an RF power harvesting insert for a wristwatch;

FIG. 2 shows a top down view of a wristwatch;

FIG. 3 shows a cross section of a wristwatch comprising an RF power harvesting insert.

### SPECIFIC DESCRIPTION

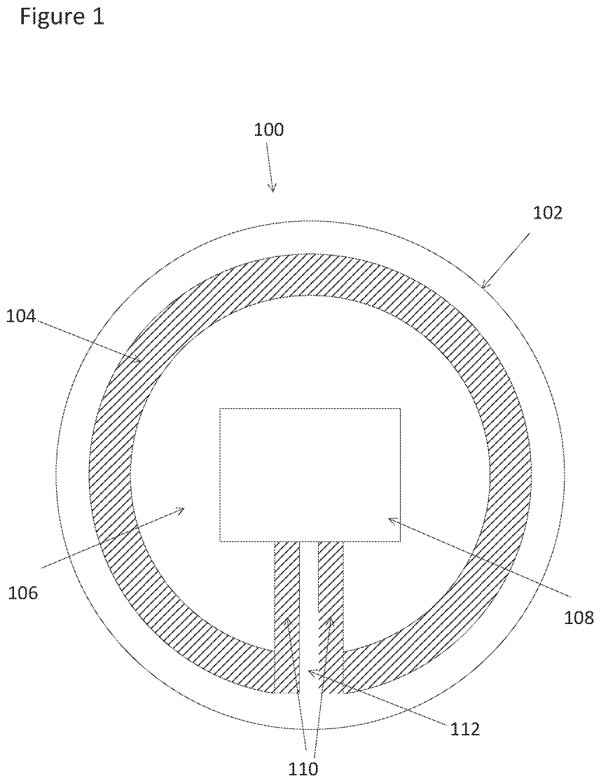

FIG. 1 shows a top down view of an RF power harvesting insert 100 for a wristwatch 200. A track of electrically conductive material 104 forming an antenna is provided on a dielectric substrate 102. The track is formed in a circular loop around the outer portion of the substrate 102 with a break 112 in the conductive track 104, forming a gap 112. In FIG. 1, the conductive track 104 lies in an annular region of the substrate surface 106 and lies parallel to the edge of the substrate 102.

A rectifier 108 is located in the middle of the surface of the substrate 106, within the bounds of the conductive track forming the antenna 104. The rectifier 108 is connected to the conductive track that forms the antenna by additional conductive track 110 that is carried on the surface of the substrate 106. The additional conductive tracks 110 connect each end of the conductive track of the antenna 104 to a respective input terminal of the rectifier 108.

The antenna 104 conducts AC electrical signals, that have been generated by the interaction with RF electromagnetic fields, via the additional conductive tracks 110, to the rectifier 108. The rectifier 108 is operable to convert these AC electrical signals into DC electrical signals that can charge a DC energy store, such as a battery or a capacitor (not shown in FIG. 1).

In FIG. 1, the antenna 104 is located in an outer annular region, with the conductive track running closer to the outer edge of the substrate than the middle of the substrate and parallel to the edge of the substrate 102. This maximises the cross section of the antenna, leading to an increased absorption cross section of the antenna, thereby increasing the power harvesting capability of the insert 100.

The rectifier 108 is located inside the boundary provided by the conductive track of the antenna 104. This allows the antenna 104 to take up the largest possible cross section, increasing the absorption of the antenna 104. The rectifier 108 may comprise lumped circuit components, stripline circuit components, or a mix of both. In preferred embodiments, the rectifier 108 comprises purely lumped circuit components to reduce the space requirement of the rectifier 108.

The width of the conductive track forming the antenna 104 can be chosen to match with impedance of the antenna 104 with that of the rectifier 108. Additionally, the diameter, or dimensions depending on the chosen shape of the antenna, can be tuned to adjust the resonant frequency of the antenna. This can be used to tune the antenna to harvest RF electromagnetic fields. The antenna may be tuned to 900 MHz, or to 2.4 GHz.

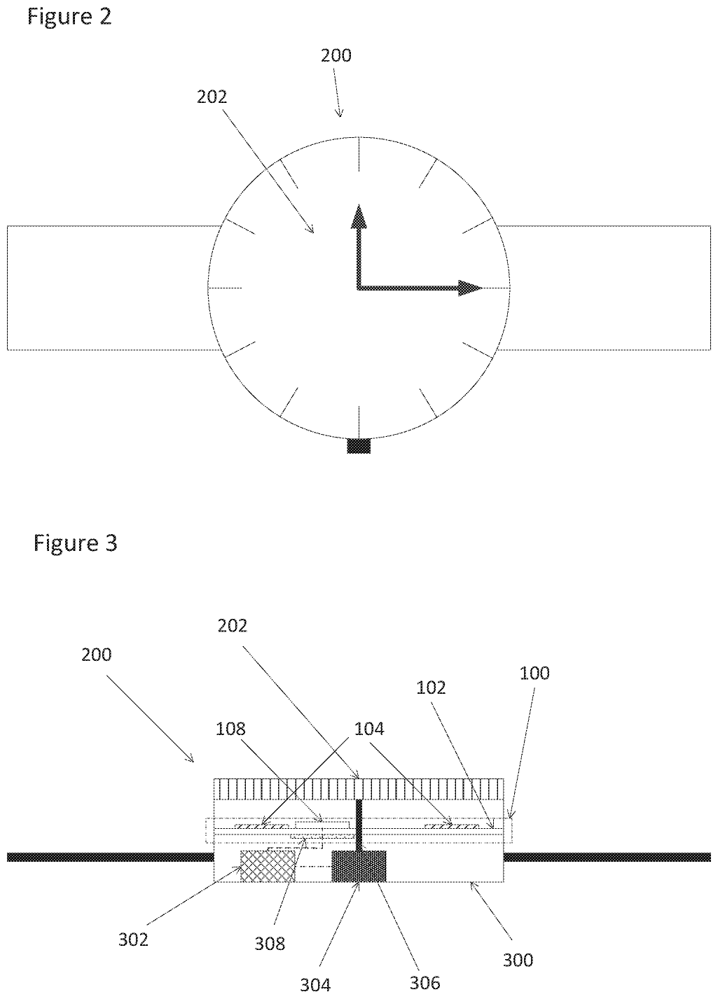

FIG. 2 shows a top down view of a wristwatch 200. The watch face 202 can clearly be seen as it forms an upper surface of the wristwatch 200.

FIG. 3 shows a cross section of the wristwatch 200 of FIG. 2. This figure clearly depicts an RF power harvesting insert 100 within the wristwatch 200. The wristwatch 200 comprises a watch face 202 on the top surface and a watch casing 300. Below the watch face 202 is the insert 100. This comprises a conductive track forming the antenna 104 and a rectifier 108, both carried on the same face of the substrate 102. Below the RF power harvesting insert 100 there is a DC energy store 302 and a timekeeping circuitry 304. This is mechanically connected to the watch face 202 via connection 306.

The antenna 104 is operable to generate an AC electrical signal from interaction with RF electromagnetic field and transmit this signal to the rectifier. At the rectifier 108, the AC signal is converted to a DC electrical signal that is used to charge the DC energy store 302. The DC energy store is connected to the timekeeping circuity 304 and is operable to supply it with electrical energy, enabling it to measure the passage of time. The time keeping circuitry is then mechanically connected to the watch face 202.

The location of the rectifier 108 of FIG. 3 differs to that of FIG. 1 in that it is not in the middle of the surface of the substrate 106. In different embodiments of the invention, the rectifier may be located within the boundary of the antenna and not necessarily at the geometric middle of the substrate surface.

In addition to this, a ground plane 308 to the rectifier 108 is provided in FIG. 3. This is a region of conductive material on the opposite surface of the substrate 102 to the rectifier 108. In the embodiment of FIG. 3, this ground plane 308 covers an area larger than that of the rectifier 108 and is directly opposite the rectifier 108. This may vary in other embodiments and could for example cover the entire bottom surface of the substrate.

In FIGS. 2 and 3, the wristwatch 200 is depicted as an analogue watch with at least a minute hand and an hour hand. This justifies the use of the mechanical connection 306 between the timekeeping circuitry 304 and the watch face 202 in FIG. 3. It should be realised that the ideas present in this disclosure could be equally applied to a digital wristwatch. In this case, the connection between the timekeeping circuitry and the watch face may be electrical and comprise at least one wire rather than the mechanical, shaft like connection 306 of FIG. 3.

While FIG. 3 shows a wristwatch 200 with the insert 100 of FIG. 1, the skilled person will realise that any alternative antenna arrangement operable to provide DC power to the DC energy store could be used. The positioning of the insert, comprising the substrate with an antenna is chosen to optimise the absorption of the antenna, given the cavity that the watch casing 300 forms around the insert. This watch casing 300, may be formed from a conductive material, thereby limiting the efficiency of the RF power harvesting antenna 104.

While in FIG. 1, the antenna 104 is circular, it should be appreciated that this is not a requirement of all embodiments of the invention. The antenna may be formed in any shape on the surface of the substrate, such as elliptical or that of any polygon. This may depend on the shape of the substrate, cavity or application of the insert.

The antenna in FIG. 1 lies parallel to the edge of the substrate, for example the spacing between the outer edge of the conductive track and the edge of the track may be even (e.g.

constant) around the edge of the antenna, for example it may be even to within a selected tolerance, for example it may be exactly parallel to that edge. This may also apply to the inside edge of the antenna (e.g. the width of the conductive track may be even around the loop).

The rectifiers considered in the above description make use of multiple electrical components, including diodes, capacitors and inductors, to achieve the AC to DC signal conversion. Separate components, often referred to as lumped components can be connected to form the rectifier. Sections of conductive track can also be placed on the substrate surface to form reactive impedances, thereby achieving the effect of lumped inductors and lumped capacitors. These are referred to as stripline components. A mixture of these lumped and stripline components can be used to form a rectifier for use in embodiments.

The substrates described herein are described as being discs, but they may also be other shapes. The discs which are used need not be circular but may be other shapes such as oval or polygonal discs. They may have an irregular or asymmetric shape, chosen to fit them into a cavity such as that described with reference to FIG. 3. In some embodiments they need not be disc shaped.

The conductive material which makes up the tracks described herein may comprise or consist essentially of a metal such as copper, gold, or other highly conductive material.

The tracks which provide the antenna loops and/or the signal links and/or bridges each have a selected width (e.g. lateral extent across the substrate). The tracks also have a selected thickness (extent normal to the plane of the substrate 9), which may be constant across their width—e.g the tracks may be rectangular in cross section. Depending on their thickness, and perhaps the depth to which they might extend into the substrate the tracks may at least partially stand proud from the surface of the substrate. The tracks may be deposited on to the substrate, for example by a subtractive technique, e.g. by providing a layer of the conductive material on to the substrate and then selectively etching it away to create the tracks. Alternatively the tracks could be laid down by an additive technique, for example by deposition of the conductive material in a pattern that provides the conductive tracks. However they are provided onto the substrate, typically the tracks conform to the surface of the substrate and are mechanically supported by it.

The thickness of either or both of the tracks may be even around the loops so the top surface of the tracks is flat, or at least follows the shape of the underlying substrate. It will be appreciated in the context of the present disclosure that by varying the width and/or thickness of the tracks their impedance can be adjusted. Such variations may be applied to the loop(s) as a whole, and/or to some selected parts of the loop(s).

The substrate may comprise an electrical insulator such as a dielectric laminate material, which may comprise a thermoset plastic. Such a substrate may have a loss tangent of between 0.02 and 0.05 at the frequency bands of the antenna. These frequency bands may comprise the 2.4 GHz WiFi band (spanning 2.4 GHz to 2.495 GHz) and the 900 MHz GSM band. The substrate may have a loss tangent of between 0.003 and 0.004 at these frequencies, for example 0.0035. The substrate may have a relative permittivity of between 2.17 to 10.2, for example between 3 and 6, for example about 5, for example 4.8. The substrate may be rigid. For example it may have a Young's modulus of at least 1 GPa, for example at least 5 GPa, for example at least 10 GPa, for example less than 40 GPa, for example less than 25 GPa. The substrate may have a young's modulus of between 10 GPa and 30 GPa, for example between 20 GPa and 25 GPa. One example of such a material is FR-4 glass epoxy.

It will, of course, be appreciated that this example of a material is given by way of example only, and that other substrate materials (e.g. RO4003® produced by Rogers Corp™, which has a relative permittivity of 3.55 and a loss tangent of 0.0027 at these frequencies, or a RO3000® series high-frequency laminate) may be used.

The substrate may be at least 100 μm thick, for example between 100 μm and 3 mm, for example between 0.125 mm and 1.52 mm. In an embodiment the substrate is rigid and is 0.75 mm thick.

The antenna may be manufactured by subtractive or additive processes as described above. It may also be manufactured by assembling pre-manufactured components together such as by adhering a conductive sheetlike element to the substrate. This may be done by laying down a preformed track of the conductive material, or by laying down a larger sheet and then etching it away. This sheetlike element may be grown or deposited as a layer on the substrate. If it is deposited a mask may be used so the deposition happens only on regions which are to carry the conductive track and/or it may be allowed to take place over a larger area and then selectively etched away. Other methods of manufacture may also be used. For example, the antenna may be manufactured by way of ‘3D printing’ whereby a three-dimensional model of the antenna is supplied, in machine readable form, to a ‘3D printer’ adapted to manufacture the antenna. This may be by additive means such as extrusion deposition, Electron Beam Freeform Fabrication (EBF), granular materials binding, lamination, photopolymerization, or stereolithography or a combination thereof. The machine readable model comprises a spatial map of the object to be printed, typically in the form of a Cartesian coordinate system defining the object's surfaces. This spatial map may comprise a computer file which may be provided in any one of a number of file conventions. One example of a file convention is a STL (STereoLithography) file which may be in the form of ASCII (American Standard Code for Information Interchange) or binary and specifies areas by way of triangulated surfaces with defined normals and vertices. An alternative file format is AMF (Additive Manufacturing File) which provides the facility to specify the material and texture of each surface as well as allowing for curved triangulated surfaces. The mapping of the antenna may then be converted into instructions to be executed by 3D printer according to the printing method being used. This may comprise splitting the model into slices (for example, each slice corresponding to an x-y plane, with successive layers building the z dimension) and encoding each slice into a series of instructions. The instructions sent to the 3D printer may comprise Numerical Control (NC) or Computer NC (CNC) instructions, preferably in the form of G-code (also called RS-274), which comprises a series of instructions regarding how the 3D printer should act. The instructions vary depending on the type of 3D printer being used, but in the example of a moving printhead the instructions include: how the printhead should move, when/where to deposit material, the type of material to be deposited, and the flow rate of the deposited material. In some embodiments the power harvesting antenna may be encapsulated in a flexible case, for example a polycarbonate case.

The tracks may be deposited or printed and other components, such as the rectifier mentioned above, may also be provided by the same process.

The antenna as described herein may be embodied in one such machine readable model, for example a machine readable map or instructions, for example to enable a physical representation of said antenna to be produced by 3D printing. This may be in the form of a software code mapping of the antenna and/or instructions to be supplied to a 3D printer (for example numerical code).

The above embodiments are to be understood as illustrative examples. Further embodiments are envisaged.

Where the operation of apparatus has been described, it will be appreciated that this is intended also as a disclosure of that operation as a method in its own right, which may be implemented using other apparatus. Likewise, the methods provided herein, and individual features of those methods may be implemented in suitably configured hardware. The configuration of the specific hardware described herein may be employed in methods implemented using other hardware.

With reference to the drawings, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

Any feature described in relation to any one embodiment may be used alone, or in combination with other features described, and may also be used in combination with one or more features of any other of the embodiments, or any combination of any other of the embodiments. And, those features may be generalised, removed or replaced as will be appreciated in view of the present disclosure and as set out in the claims. Furthermore, equivalents and modifications not described above may also be employed without departing from the scope of the invention, which is defined in the accompanying claims.

1. An RF power harvesting insert for a wristwatch, the insert comprising:
a dielectric substrate; and
an antenna tuned to harvest power from RF electromagnetic fields to provide a radiofrequency electrical signal and comprising a track of electrically conductive material on the substrate, wherein the antenna is carried by an annular region of a first surface of the substrate.

2. The insert of claim 1 comprising a rectifier carried by the substrate for converting the radio frequency signal into a DC signal for charging a DC energy store.

3. The insert of claim 2 wherein the rectifier is surrounded by the annular region.

4. The insert of claim 3 comprising conductive track on the substrate connecting the antenna to the rectifier and arranged to provide impedance matching between the antenna and the rectifier.

5. The insert of claim 2 wherein the DC energy store is for powering a movement of the wristwatch.

6. The insert of claim 2 wherein the rectifier comprises at least some strip line components.

7. The insert of claim 2 wherein the rectifier comprises at least some lumped components.

8. The insert of claim 2 wherein the rectifier is disposed on the same side of the substrate as the antenna.

9. The insert of claim 8 comprising a region of conductive material arranged to provide a ground plane for the rectifier.

10. The insert of claim 9 wherein the ground plane is disposed on the opposite side of the substrate from the antenna.

11. The insert of claim 1 wherein the antenna is circular.

12. The insert of claim 1 wherein the annular region is disposed around the edge of a first surface of the substrate.

13. The insert of claim 1 further comprising a face for a wristwatch, wherein the dielectric substrate is arranged to be hidden behind the face when the insert is installed in a watch.

14. The insert of claim 13 wherein the face consists essentially of a non-magnetic electrical insulator.

15. The insert of claim 1 wherein the face carries hands for indicating the passage of time, and the hands consists essentially of a non-magnetic electrical insulator.

16. The insert of claim 1 wherein the antenna is tuned to couple with signals in a frequency band of 800 MHz to 1 GHz.

17. The insert of claim 1 wherein the antenna is tuned to couple with signals in a frequency band of 800 MHz to 1 GHz.

18. The insert of claim 1 further comprising a DC energy store for powering a movement of a wristwatch and arranged to be charged by power supplied from the rectifier.

19. A wristwatch comprising
a watch face for indicating the passage of time; and
a watch body holding timekeeping circuitry behind the face, and an antenna disposed on a dielectric substrate interposed between the time keeping circuitry and the face, wherein the antenna is tuned to harvest power from RF electromagnetic fields to provide electrical power for charging a DC energy store of the wristwatch, wherein the DC energy store powers the timekeeping circuitry.

20. The wristwatch of claim 19, wherein the antenna is provided by an RF power harvesting insert comprising the dielectric substrate and the antenna; and
Wherein the antenna is tuned to harvest power from RF electromagnetic fields to provide a radiofrequency electrical signal and comprises a track of electrically conductive material on the substrate, wherein the antenna is carried by an annular region of a first surface of the dielectric substrate.
